(19) United States
(12) Patent Application Publication
(10) Pub. No.: US 2026/0058394 A1
(43) Pub. Date: Feb. 26, 2026

(54) ELECTRICAL CONNECTOR TERMINAL AND ELECTRICAL CONNECTOR STRUCTURE

(71) Applicant: Greenconn Technology (Ganzhou) Ltd., Ganzhou (CN)

(72) Inventors: Guo-Yan QIU, Ganzhou (CN); Cai-Xian WU, Ganzhou (CN); Chao HUANG, Ganzhou (CN)

(21) Appl. No.: 19/029,368

(22) Filed: Jan. 17, 2025

(30) Foreign Application Priority Data
Aug. 22, 2024 (CN) 2024111586994

(51) Int. Cl. H01R 13/422; H01R 13/02; H01R 13/04; H01R 13/24; H01R 13/631

(52) U.S. Cl. CPC H01R 13/4223; H01R 13/025; H01R 13/04; H01R 13/24; H01R 13/631

(57) ABSTRACT

An electrical connector terminal includes a mating housing. The mating housing has a mating opening, a limiting element away from the mating opening and an elastic element adjacent to but separated from the limiting element. The elastic element includes a first portion, a second portion extending along a vertical direction and a third portion extending along a length direction of the mating opening. The second portion is connected to the first portion and the third portion, and the second portion and the third portion of the elastic element are formed in L-shaped. The limiting element includes a limiting portion extending along the length direction and an auxiliary portion inclined toward the first portion of the elastic element. The limiting portion is connected to the auxiliary portion. The auxiliary portion is configured to abut one end of the first portion of the elastic element.

### BACKGROUND OF THE INVENTION

### (a) Field of the Invention

The present disclosure relates to an electrical connector terminal and an electrical connector structure, and more particularly, to the electrical connector terminal having a limiting element and an elastic element to be stabilized in a housing cavity and the electrical connector structure with this configuration of the electrical connector terminal.

### (b) Description of the Prior Art

In general, electrical connector terminals currently in markets are used in a connecting field of electronic signals and powers. The main function of the electrical connector terminals is to provide electrical connection between various electronic devices to ensure signal transmission. However, as the size of electronic device products is gradually reduced, the size of the electrical connector structure is required to be reduced as well. Therefore, under this limitation of space structures, the electrical connector terminals may not be readily to be stable in the electrical connector structure, which may affect the connecting effect and cause unstable flaws.

### SUMMARY OF THE INVENTION

One aspect of the present disclosure is an electrical connector terminal, which has a L-shaped elastic element to allow the electrical connector terminal to be inserted into an electrical connector housing and firmly fix in a cavity of an electrical connector housing.

According to an embodiment of the present disclosure, an electrical connector terminal includes a mating housing. The mating housing has a mating opening, a limiting element away from the mating opening and an elastic element adjacent to but separated from the limiting element. The elastic element includes a first portion which is inclined, a second portion extending along a vertical direction and a third portion extending along a length direction of the mating housing. The vertical direction is perpendicular to the length direction. The second portion is connected to the first portion and the third portion. The second portion and the third portion of the elastic element are formed in L-shaped. The limiting element includes a limiting portion extending along the length direction and an auxiliary portion inclined toward the first portion of the elastic element. The limiting portion is connected to the auxiliary portion. The auxiliary portion is configured to abut one end of the first portion of the elastic element.

In one embodiment of the present disclosure, the mating housing has an abutting element, and the auxiliary portion has a bending portion bent toward the abutting element.

In one embodiment of the present disclosure, the abutting element has a first protruding portion protruding away from the bending portion, the first protruding portion of the abutting element is separated from the bending portion of the auxiliary portion to define a moving space for the first protruding portion to move along the vertical direction.

In one embodiment of the present disclosure, a bottom of the mating housing, the abutting element and the limiting element are defined a mating space for a conductive male pin to be inserted into the mating space.

In one embodiment of the present disclosure, the mating opening of the mating housing is configured to receive the conductive male pin such that the conductive male pin is inserted into the mating space.

In one embodiment of the present disclosure, the bottom of the mating housing has a second protruding portion protruding toward the abutting element, and the first protruding portion is positionally corresponded to the second protruding portion in the vertical direction.

In one embodiment of the present disclosure, the electrical connector terminal further includes a wiring base body. The wiring body is connected to the mating housing and integrally formed with the mating housing. The wiring body is configured to receive a signal line such that the conductive male pin is electrically connected to the signal line by the mating housing and the wiring base body.

Another aspect of the present disclosure is an electrical connector structure.

According to an embodiment of the present disclosure, an electrical connector structure includes the electrical connector terminal and an electrical connector housing. The electrical connector housing has a main body. The main body has a cavity, a partition block disposed on the main body, a first buckle area and a second buckle area. The first buckle area and the second buckle area are located at opposite two sides of the partition block. When the electrical connector terminal is inserted into the cavity, the second portion and the third portion of the elastic element are configured to contact the partition block. The limiting portion of the limiting element is configured to contact the second buckle area to stabilize the electrical connector terminal in the cavity.

In one embodiment of the present disclosure, the electrical connector housing has a buckle positioning element. A first buckle portion is located at one end of the buckle positioning element. A second buckle portion is located in the middle of the buckle positioning portion. When the buckle positioning portion is buckled to the main body, the first portion of the elastic element of the electrical connector terminal is partially located in the first buckle area, and the second buckle portion of the buckle positioning element is located in the second buckle area of the main body.

In one embodiment of the present disclosure, the electrical connector housing has a mating end, and when the electrical connector terminal is stabilized in the cavity, the mating end is aligned with the mating opening of the electrical connector terminal.

In the embodiments of the present disclosure, the electrical connector terminal of the electrical connector structure has the elastic element, and the second portion and the third portion of the elastic element are formed in L-shaped. The L-shaped portion of the elastic element of the electrical connector terminal may be configured to contact the partition block of the electrical connector housing. In addition, the electrical connector terminal also has a limiting element separated from the elastic element. The limiting element may be configured to contact the second buckle area of the electrical connector housing such that the electrical connector terminal may receive the conductive male pin, and the electrical connector terminal may also be fixed in the cavity of the electrical connector housing to achieve electrical connection between electronic devices.

To enable a further understanding of the said objectives and the technological methods of the invention herein, the brief description of the drawings below is followed by the detailed description of the preferred embodiments.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a stereoscopic view of an electrical connector terminal according to one embodiment of the present disclosure.

FIG. 2 illustrates a cross-sectional view of a mating housing of an electrical connector terminal according to one embodiment of the present disclosure.

FIG. 3 illustrates a schematic view that an electrical connector terminal is connected to a signal line according to one embodiment of the present disclosure.

FIG. 4 illustrates a cross-sectional view that an electrical connector structure is connected to a signal line according to one embodiment of the present disclosure.

FIG. 5 illustrates an enlarged view of the electrical connector structure of FIG. 4.

FIG. 6 illustrates a schematic view that an electrical connector terminal is connected with a conductive male pin and a signal line according to one embodiment of the present disclosure.

FIG. 7 illustrates a cross-sectional view that a conductive male pin is inserted into an electrical connector structure according to one embodiment of the present disclosure.

### DETAILED DESCRIPTION OF THE PREFERRED EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper,” “front,” “back” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

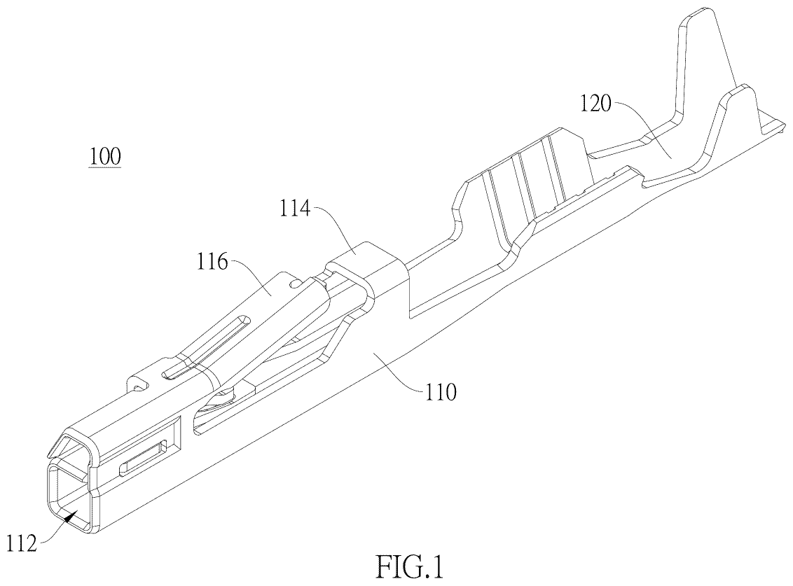

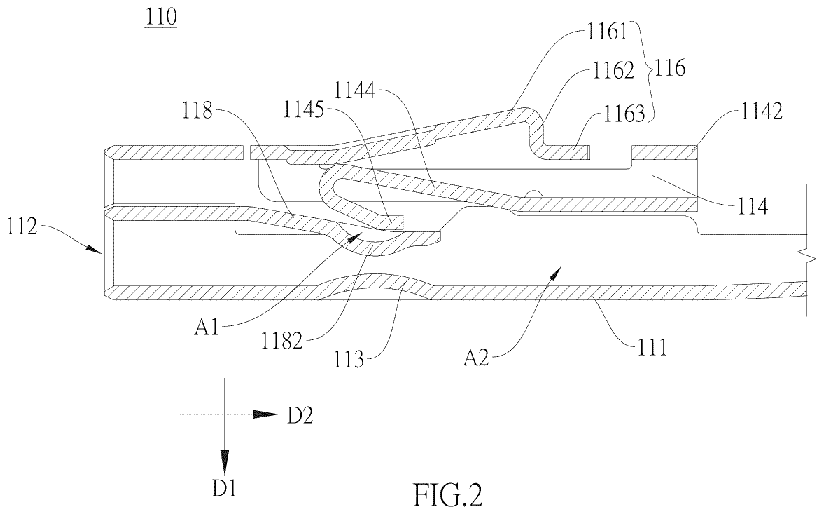

Please refer to FIG. 1 and FIG. 2, FIG. 1 illustrates a stereoscopic view of an electrical connector terminal 100 according to one embodiment of the present disclosure, and FIG. 2 illustrates a cross-sectional view of a mating housing 110 of the electrical connector terminal 100 according to one embodiment of the present disclosure. In FIG. 1 and FIG. 2, the electrical connector terminal 100 includes the mating housing 110. The mating housing 110 of the electrical connector terminal 100 has a mating opening 112, a limiting element 114 away from the mating opening 112, and an elastic element 116 adjacent to but separated from the limiting element 114. For example, the mating opening 112 and the limiting element 114 of the mating housing 110 are located on opposite two sides of the mating housing 110, and the elastic element 116 of the mating housing 110 is located between the mating opening 112 and the limiting element 114. The elastic element 116 of the mating housing 110 includes a first portion 1161, a second portion 1162 and a third portion 1163. The first portion 1161 is inclined relative to a length direction D2 of the mating housing 110. The second portion 1162 extends along a vertical direction D1. The third portion 1163 extends along the length direction D2 of the mating housing 110. The vertical direction D1 is perpendicular to the length direction D2.

In some embodiments, the second portion 1162 of the elastic element 116 is connected between the first portion 1161 and the third portion 1163. It is noted that the second portion 1162 and the third portion 1163 of the elastic element 116 are formed in L-shaped. The limiting element 114 of the mating housing 110 includes a limiting portion 1142 extending along the length direction D2 of the mating housing 110 and an auxiliary portion 1144 inclined toward the first portion 1161 of the elastic element 116. The limiting element 114 of the limiting portion 1142 is connected to the auxiliary portion 1144 of the limiting element 114, and the auxiliary portion 1144 of the limiting element 114 is configured to abut one end of the first portion 1161 of the elastic element 116.

In some embodiments, the mating housing 110 has an abutting element 118. The abutting element 118 of the mating housing 110 is located between a bottom 111 of the mating housing 110 and the elastic element 116 of the mating housing 110. In addition, the auxiliary portion 1144 of the limiting element 114 of the mating housing 110 further has a bending portion 1145 bent toward the abutting element 118. The bending portion 1145 of the auxiliary portion 1144 is bent toward the bottom 111 of the mating housing 110. The abutting element 118 of the mating housing 110 has a first protruding portion1182 protruding away from the bending portion 1145. That is to say, the abutting element 118 has the first protruding portion1182 protruding toward the bottom 111 of the mating housing 110. It is noted that the first protruding portion 1182 protruding from the abutting element 118 toward the bottom 111 of the mating housing 110 is separated from the bending portion 1145 bending toward the abutting element 118 of the auxiliary portion 1144 to define a moving space A1 for the first protruding portion 1182 to move along the vertical direction D1.

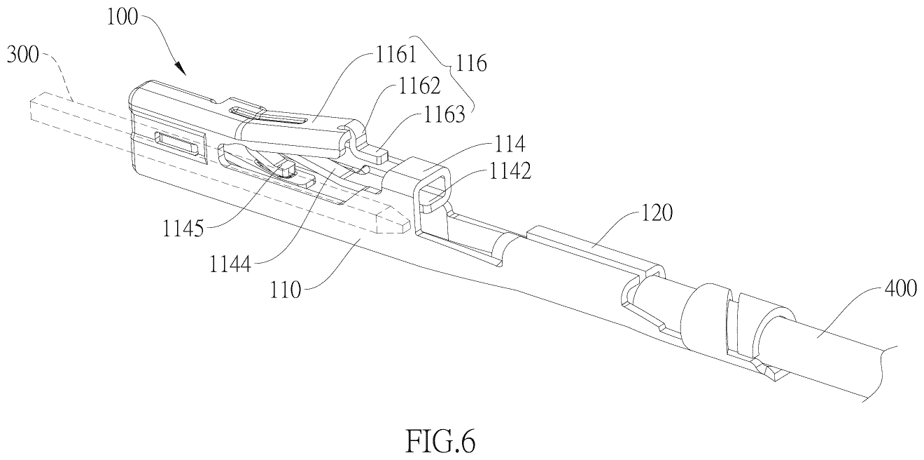

In some embodiments, the bottom 111, the abutting element 118 and the limiting element 114 of the mating housing 110 define a mating space A2 for a conductive male pin 300 (described in FIG. 6) to be inserted into the mating space A2. Specifically, the mating opening 112 of the mating housing 110 may be configured to receive the conductive male pin 300 so that the tip of the conductive male pin 300 may enter in the mating space A2. When the tip of the conductive male pin 300 enters in the mating space A2, the first protruding portion1182 of the abutting element 118 protruding toward the bottom 111 of the mating housing 110 may be configured to abut the conductive male pin 300, so that the conductive male pin 300 may be firmly fixed in the electrical connector terminal 100. In addition, when the conductive male pin 300 is inserted into the mating housing 110, the moving space A1 of the mating housing 110 allows the first protruding portion 1182 of the abutting element 118 to move along the vertical direction D1.

In addition, the bottom 111 of the mating housing 110 has a second protruding portion 113 protruding toward the abutting element 118. It is worth noting that the position of the first protruding portion 1182 of the abutting element 118 of the mating housing 110 corresponds to the position of the second protruding portion 113 of the bottom 111 of the mating housing 110 in the vertical direction D1. The first protruding portion 1182 and the second protruding portion 113 protruding toward each other can provide a fixing effect, so that after the tip of the conductive male pin 300 enters the insertion space A2, the conductive male pin 300 can be firmly connected to the electrical connector terminal 100.

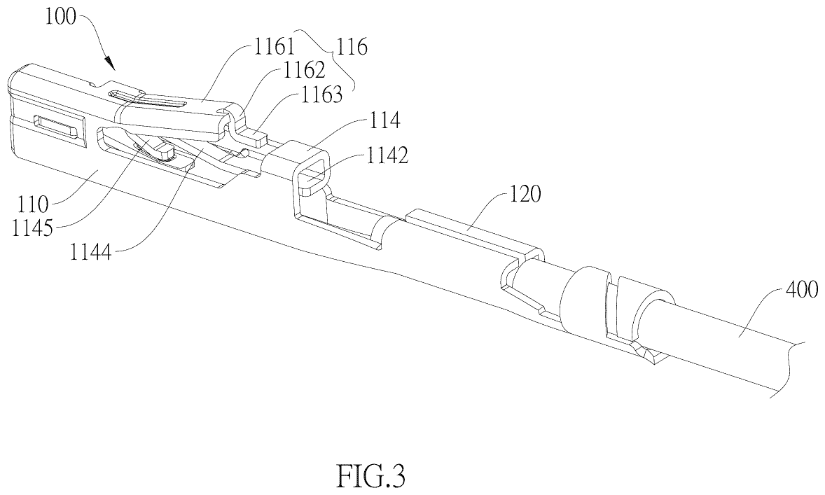

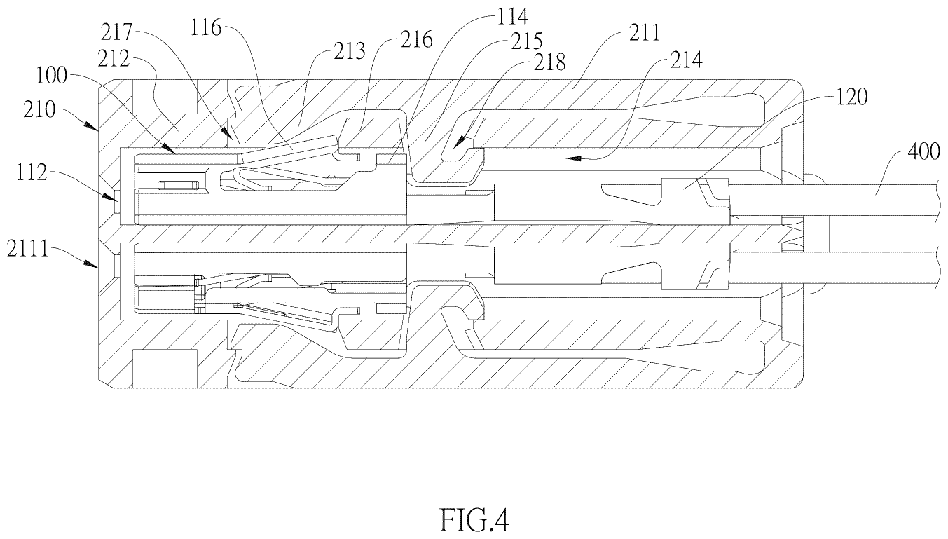

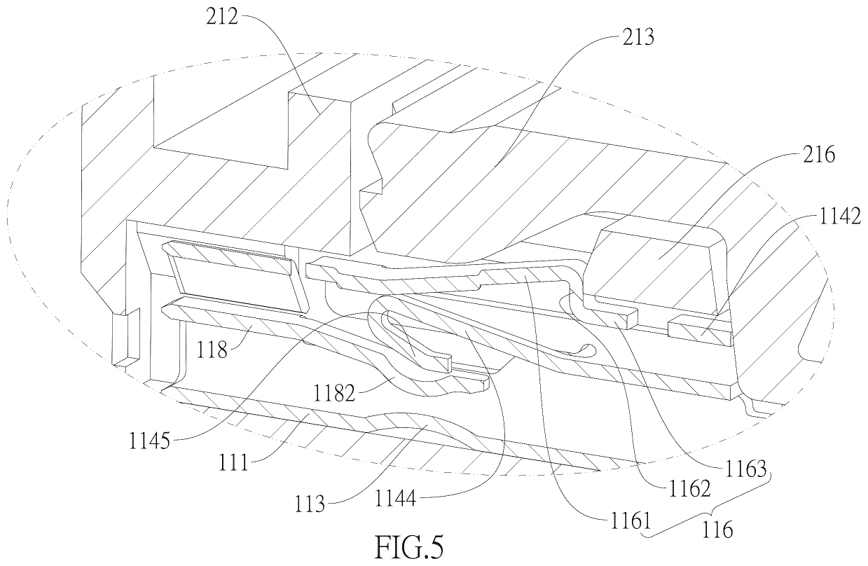

Please refer to FIG. 3 to FIG. 5, FIG. 3 illustrates a schematic view that the electrical connector terminal 100 is connected to a signal line 400 according to one embodiment of the present disclosure, FIG. 4 illustrates a cross-sectional view that the electrical connector structure 200 is connected to the signal line 400 according to one embodiment of the present disclosure, and FIG. 5 illustrates an enlarged view of the electrical connector structure 200 of FIG. 4. In FIG. 3 to FIG. 5, the electrical connector terminal 100 further includes a wiring body 120. The wiring body 120 is connected to the mating housing 110 and is integrally formed with the mating housing 110.

In some embodiments, the wiring body 120 is disposed at one side of the mating housing 110 away from the mating opening 112. The wiring body 120 is configured to receive the signal line 400. For example, the signal line 400 may be disposed on the wiring body 120 such that the signal line 400 is firmly connected to the wiring body 120. When the conductive male pin 300 is inserted into the mating housing 110, the conductive male pin 300 is electrically connected to the signal line 400 by the configuration of the mating housing 110 and the wiring body 120 of the electrical connector terminal 100 to achieve the signal transmission of the conductive male pin 300 and the signal line 400.

In addition, the electrical connector structure 200 includes the electrical connector terminal 100 above-mentioned and an electrical connector housing 210. The electrical connector housing 210 of the electrical connector structure 200 has a main body 212. The main body 212 of the electrical connector housing 210 has a cavity 214, a partition block 216 disposed on the main body 212, a first buckle area 217 and a second buckle area 218. The first buckle area 217 and the second buckle area 218 are located at opposite two sides of the partition block 216. It is noted that when the electrical connector terminal 100 is inserted into the cavity 214 of the electrical connector housing 210, the second portion 1162 and the third portion 1163 formed with L-shaped of the elastic element 116 of the electrical connector terminal 100 may be configured to contact the partition block 216 of the electrical connector housing 210, and the limiting portion 1142 of the limiting element 114 of the electrical connector terminal 100 may be configured to contact the second buckle area 218 of the electrical connector housing 210, so that the electrical connector terminal 100 may be firmly fixed in the cavity 214 of the electrical connector housing 210 to achieve a fixed effect. Additionally, the electrical connector housing 210 has a mating end 2111. When the electrical connector terminal 100 is fixed in the cavity 214 of the electrical connector housing 210, the mating end 2111 of the electrical connector housing 210 is aligned with the mating opening 112 of the electrical connector terminal 100.

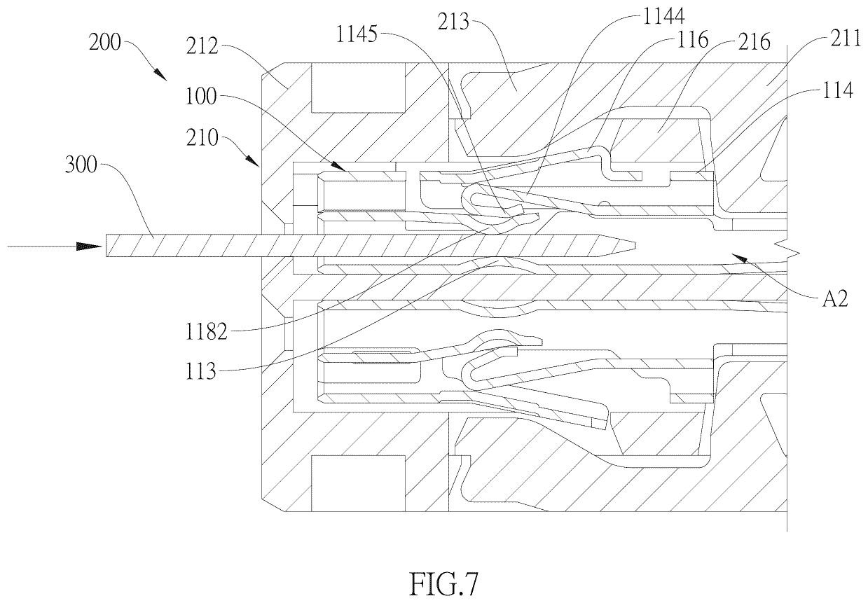

Please refer to FIG. 6 and FIG. 7, FIG. 6 illustrates a schematic view that the electrical connector terminal 100 is connected with the conductive male pin 300 and the signal line 400 according to one embodiment of the present disclosure, and FIG. 7 illustrates a cross-sectional view that the conductive male pin 300 is inserted into the electrical connector structure 200 according to one embodiment of the present disclosure. In FIG. 6 and FIG. 7, the electrical connector housing 210 also has a buckle positioning element 211. A first buckle portion 213 is located at one end of the buckle positioning element 211 of the electrical connector housing 210, and a second buckle portion 215 is located in the middle of the buckle positioning element 211. It is noted that when the buckle positioning element 211 of the electrical connector housing 210 is buckled to the main body 212, the second buckle portion 215 of the buckle positioning element 211 is located in the second buckle area 218 of the main body 212, and the first portion 1161 of the elastic element 116 of the electrical connector terminal 100 is partially located in the first buckle area 217 of the electrical connector housing 210.

In summary, the electrical connector terminal 100 of the electrical connector structure 200 has the elastic element 116, and the second portion 1162 and the third portion 1163 of the elastic element 116 are formed in L-shaped. The L-shaped portion of the elastic element 116 of the electrical connector terminal 100 may be configured to contact the partition block 216 of the electrical connector housing 210. In addition, the electrical connector terminal 100 also has a limiting element 114 separated from the elastic element 116. The limiting element 114 may be configured to contact the second buckle area 218 of the electrical connector housing 210 such that the electrical connector terminal 100 may receive the conductive male pin 300, and the electrical connector terminal 100 may also be fixed in the cavity 214 of the electrical connector housing 210 to achieve electrical connection and signal transmission between electronic devices. That is, when the size of the electrical connector structure 200 is reduced, the electrical connector terminal 100 above-mentioned may still be firmly fixed in the electrical connector structure 200 under the limitation of the space structure through the design of the electrical connector terminal 100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An electrical connector terminal, comprising:
a mating housing having a mating opening, a limiting element away from the mating opening and an elastic element adjacent to but separated from the limiting element, wherein the elastic element comprises a first portion which is inclined, a second portion extending along a vertical direction and a third portion extending along a length direction of the mating housing, the vertical direction is perpendicular to the length direction, the second portion is connected to the first portion and the third portion, and the second portion and the third portion of the elastic element are formed in L-shaped,
wherein the limiting element comprises a limiting portion extending along the length direction and an auxiliary portion inclined toward the first portion of the elastic element, the limiting portion is connected to the auxiliary portion, and the auxiliary portion is configured to abut one end of the first portion of the elastic element.

2. The electrical connector terminal of claim 1, wherein the mating housing has an abutting element, and the auxiliary portion has a bending portion bent toward the abutting element.

3. The electrical connector terminal of claim 2, wherein the abutting element has a first protruding portion protruding away from the bending portion, the first protruding portion of the abutting element is separated from the bending portion of the auxiliary portion to define a moving space for the first protruding portion to move along the vertical direction.

4. The electrical connector terminal of claim 3, wherein a bottom of the mating housing, the abutting element and the limiting element are defined a mating space for a conductive male pin to be inserted into the mating space.

5. The electrical connector terminal of claim 4, wherein the mating opening of the mating housing is configured to receive the conductive male pin such that the conductive male pin is inserted into the mating space.

6. The electrical connector terminal of claim 4, wherein the bottom of the mating housing has a second protruding portion protruding toward the abutting element, and the first protruding portion is positionally corresponded to the second protruding portion in the vertical direction.

7. The electrical connector terminal of claim 4, further comprising:
a wiring body connected to the mating housing and integrally formed with the mating housing, wherein the wiring body is configured to receive a signal line such that the conductive male pin is electrically connected to the signal line by the mating housing and the wiring body.

8. An electrical connector structure, comprising:
the electrical connector terminal of claim 1 ; and
an electrical connector housing having a main body, wherein the main body has a cavity, a partition block disposed on the main body, a first buckle area and a second buckle area, and the first buckle area and the second buckle area are located at opposite two sides of the partition block,
wherein when the electrical connector terminal is inserted into the cavity, the second portion and the third portion of the elastic element are configured to contact the partition block, and the limiting portion of the limiting element is configured to contact the second buckle area to stabilize the electrical connector terminal in the cavity.

9. The electrical connector structure of claim 8, wherein the electrical connector housing has a buckle positioning elemen, and a first buckle portion is located at one end of the buckle positioning element, a second buckle portion is located in the middle of the buckle positioning portion, when the buckle positioning portion is buckled to the main body, the first portion of the elastic element of the electrical connector terminal is partially located in the first buckle area, and the second buckle portion of the buckle positioning element is located in the second buckle area of the main body.

10. The electrical connector structure of claim 8, wherein the electrical connector housing has a mating end, and when the electrical connector terminal is stabilized in the cavity, the mating end is aligned with the mating opening of the electrical connector terminal.
